(19) United States
(12) Patent Application Publication
(10) Pub. No.: US 2003/0183985 A1
(43) Pub. Date: Oct. 2, 2003

(54) Ceramic casting apparatus and method

(76) Inventors: Alan James Clegg, Norfolk (GB); Christopher Bernard Moore, Snettisham (GB)

Correspondence Address: NEEDLE & ROSENBERG P C, 127 PEACHTREE STREET N E, ATLANTA, GA, 30303-1811, US

(21) Appl. No.: 10/149,935

(22) PCT Filed: Dec. 15, 2000
(86) PCT No.: PCT/GB00/04818

(30) Foreign Application Priority Data
Dec. 16, 2000 (GB) 9929651.9
Jun. 28, 2000 (GB) 0015772.7

(51) Int. Cl. B29C 45/00; B28B 1/26

(52) U.S. Cl. 264/328.2; 425/468; 425/451.9; 425/84

(57) ABSTRACT

Apparatus for manufacturing ceramic articles comprising two outer female moulds (22, 122; 24, 124), having co-operating mating faces (30, 130; 32, 132) and a male mould (34, 36, 160, 166) arranged, in use, to be disposed between the female moulds (22, 122; 24, 124), wherein the female moulds (24, 122; 24, 124) are arranged to be relatively movable in a direction substantially perpendicular to the plane of the mating faces (30, 130; 32, 132) thereby permitting the female moulds (22, 122; 24, 124) to form a seal against the male mould (34, 36, 160, 166) and two corresponding parts of an article to be cast the male mould to be removed and the two parts to be joined.

This invention relates to an apparatus and method for casting ceramic articles such as toilet bowls, requiring moulds with more than two parts, for example. More particularly, this invention relates to the pressure casting of such articles.

The traditional route for the production of ceramic items is to use plaster slip casting. In this process the clay slip is de-watered by pouring it into a plaster mould. The plaster absorbs the water and must be dried periodically thus preventing continuous operation. This process is therefore slow but requires low capital investment.

Pressure casting of ceramic slips is a known, but more recently developed process. The process is used to manufacture a wide variety of sanitaryware, tableware and technical products. This process operates by closing a microporous mould using a mechanical means, and introducing pressurised clay slip into the closed mould. The water in the clay slip is filtered through the structure of the mould leaving clay pieces of sufficient strength to support their own weight. The clay pieces are de-moulded by applying compressed air through the mould porous structure, thus discharging them.

The moulds can be contained within metal frames, which are used to protect them from external damage, support the microporous material against internal pressure, and allow the moulds to be hung on a machine in correct alignment.

Whilst a wide variety of shapes can be produced using two piece moulds, some shapes can only be made by the use of more than two-mould pieces.

Toilet bowls (commonly called “bowls”) cannot be made using any existing process, with moulds comprising less than four pieces. More complex designs require the use of a five piece mould.

This does not raise fundamental problems when using traditional slip casting. However, a pressure casting machine designed to produce “bowls” currently requires two axes of clamping to close and retain the four piece moulds in position during the filtration process. An example of such a machine is disclosed in UK Patent Application Number 9721709 in the name of the present applicants. This machine requires hydraulic rams mounted externally of the mould pieces to provide the clamping force in the second axis to counteract the pressure of the clay slip introduced into the moulds during the casting process. The externally mounted rams in turn are mounted on a strengthened carriage assembly, which inevitably increases the cost, complexity and size of the machine.

The present invention seeks to overcome or at least mitigate the problems of the prior art.

One aspect of the invention provides apparatus for manufacturing ceramic articles comprising two outer female moulds, having co-operating mating faces and a male mould arranged, in use, to be disposed between the female moulds. The female moulds are arranged to be relatively movable in substantially perpendicular to the plane of the mating faces thereby permitting the female moulds to form a seal against the male mould and two corresponding parts of an article to be cast. The male mould is then removed and the two parts are joined. Preferably, the male mould may be removed in an axis substantially parallel to the plane of the mating faces.

According to an optional feature of this aspect of the invention there may further comprise a setter arranged to support the article when joined.

According to another optional feature of this aspect of the invention means may be provided to ensure correct alignment of the female moulds is achieved.

According to a further optional feature of this aspect of the invention two male moulds may be provided. Preferably, the two male moulds may be arranged in back to back relationship. More preferably, the male moulds may be mounted on a track so as to permit the male moulds to be moved out of the axis of the female moulds.

According to a second aspect of the present invention there is provided a method of making ceramic articles comprising the steps of: casting two parts of an article in apparatus comprising two female moulds and a male mould; separating the article parts whilst held in the female moulds; removing the male mould; bringing the two female moulds together and joining the two parts of the article by suitable means. Preferably the method may comprise the steps of introducing a setter so as to support the article and subsequently demoulding the article from the female moulds.

According to a third aspect of the present invention there is provided apparatus for manufacturing ceramic articles comprising two outer female moulds located within respective mould cases and having co-operating mating faces and a male mould arranged, in use, to be disposed in a mould cavity formed by the female moulds, the female moulds being arranged to be relatively movable in a first axis substantially perpendicular to the plane of the mating faces such that the female moulds may be brought into contact the article being cast between the female moulds and the male mould and wherein the forces induced by the pressurised slip during the manufacturing process are thereby contained within the mould cases.

Preferably the male mould may be associated with clamping means. More preferably the clamping means is disposed in use within the mould cavity. Even more preferably the internal clamping means may be so constructed and arranged as to exert a clamping force in a second axis.

According to an optional feature of this aspect of the invention, the clamping means may be located between a face of the male mould and an inner face of at least one of the female moulds.

According to a second optional feature of this aspect of the invention, fluid may be introduced into the clamping means to provide the clamping force. Preferably the clamping means may comprise a pressure pad. More preferably the pressure pad may comprise a chamber enveloped by resilient material. Even more preferably the fluid may be introduced into the chamber.

According to another optional feature of this aspect of the invention the article may be cast in a single piece.

According to a further optional feature of this aspect of the invention two male moulds may be provided. Preferably the moulds are arranged to be withdrawn in substantially opposite directions.

According to a still further optional feature of this aspect of the invention a third male mould may be provided in a third axis. Preferably, the ceramic article may be a toilet bowl and the third male mould is arranged so as to form a waste pipe portion thereof.

According to a yet further optional feature of this aspect of the invention a single axis casting machine may be provided which may comprise a plurality of apparatus suspended from an overhead beam.

According to a fourth aspect of aspect of the present invention there is provided a method of making ceramic articles comprising the steps of: i) introducing a male mould into an envelope formed by two female moulds located within respective mould cases; ii) clamping the male mould so as to resist the pressurisation of clay slip, once introduced in such a way as to contain the forces exerted by the slip within the mould cases: iii) introducing pressurised clay slip so as to cast the article; iv) de-moulding the moulds. Preferably the male mould may be clamped using clamping means. More preferably the clamping means may be a pressure pad.

According to an optional feature of this aspect of the invention two male moulds may be provided. Preferably the male moulds are de-moulded in substantially opposite directions.

According to a fifth aspect of the present invention there is provided a pressure pad for use in the casting of ceramic articles which comprises a chamber enveloped by resilient material wherein fluid may be introduced under pressure into the chamber thus causing a clamping force to be exerted in substantially a single axis. Preferably the chamber may comprise a coil of resilient tubing. Alternatively the chamber may comprise a resilient bag.

According to an optional feature of this aspect of the present invention the resilient material may comprise rubber.

According to a second optional feature of this aspect of the invention, an aperture may be provided therein for the passage of a support tube upon which an associated mould may be mounted.

According to a sixth aspect of the present invention there is provided a method of forming a pressure pad for use in a casting machine comprising the steps of: i) placing coiled tubing having a closed and an open end in a mould; ii) pouring a liquid into the mould so as to surround the coiled tubing; and iii) allowing the liquid to cure so as to form a resilient envelope surrounding the tubing; wherein a fluid may be introduced into the tubing through the open end thereof once the pad is cured so as to cause to the pad to expand.

Exemplary embodiments of the invention are now described, by way of example only, with reference to the accompanying drawings in which:

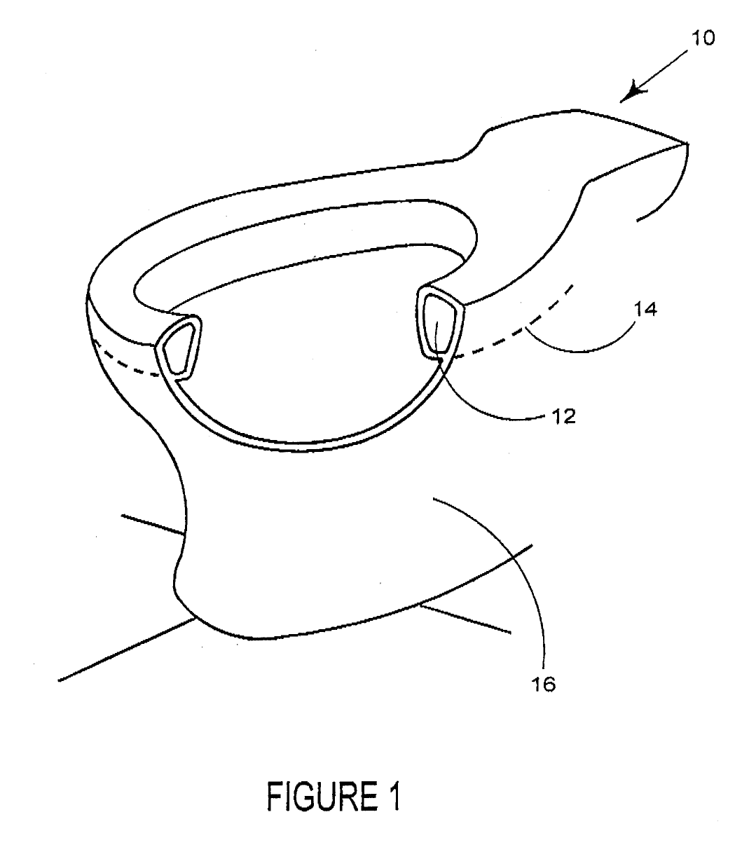

FIG. 1 is a partial cut-away perspective view of a box rim toilet bowl manufactured using a prior art process;

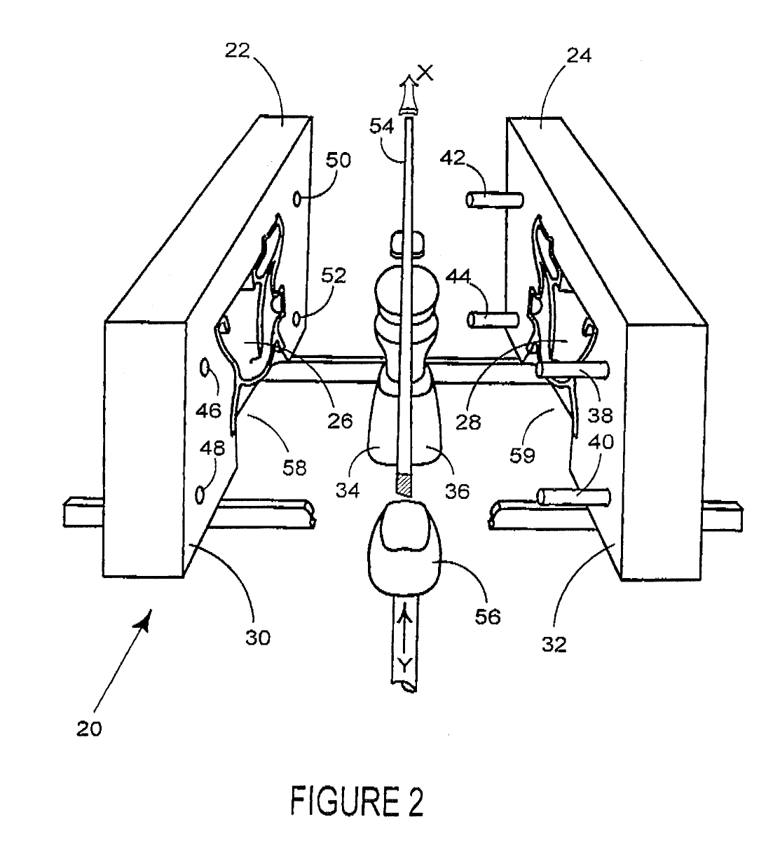

FIG. 2 is a perspective view of casting apparatus according to one embodiment of the present invention;

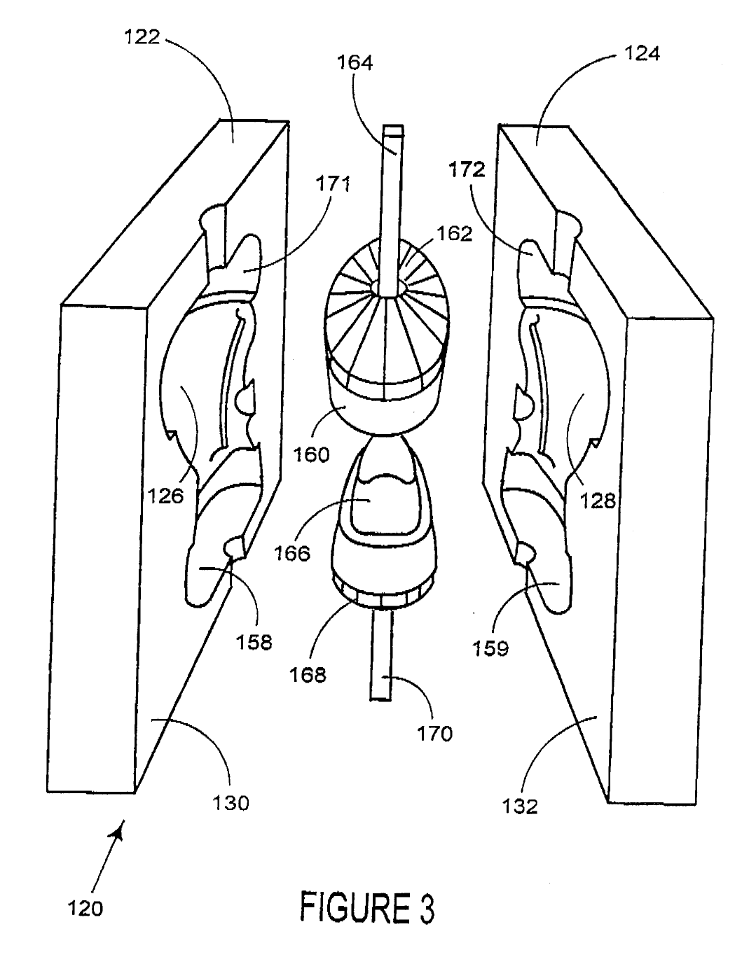

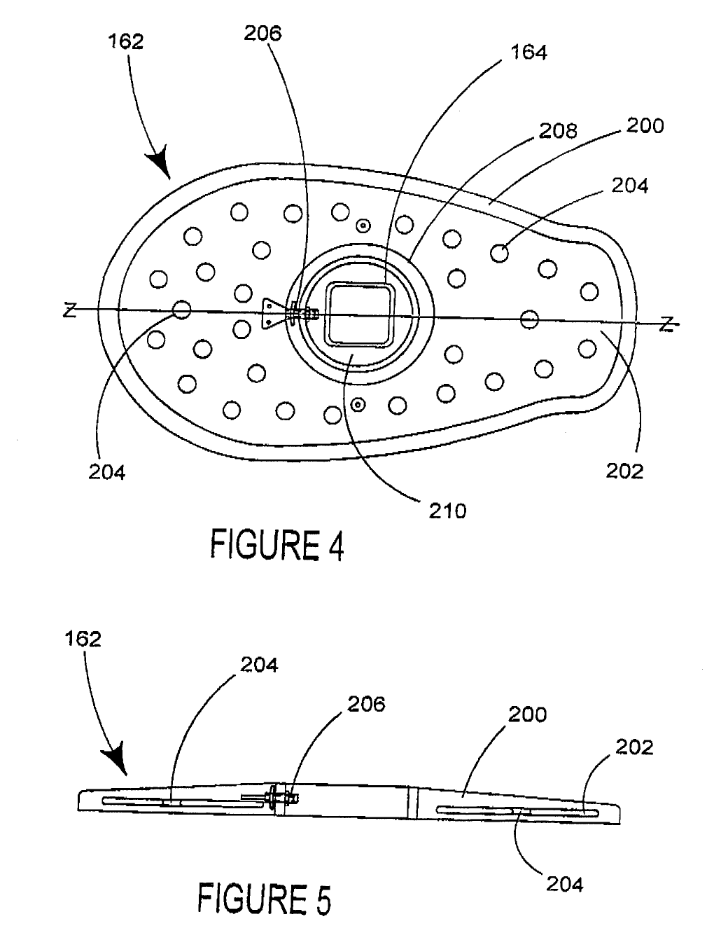

FIG. 3 is a perspective view of casting apparatus according to a second embodiment of the invention; FIG. 4 is a plan view cross-section through a pressure pad assembly of the second embodiment of the invention.

FIG. 5 is a cross sectional view through the pressure pad of FIG. 4 along the axis Z-Z.

Referring to FIG. 1, it is common practice to produce American “box rim” bowls 10 by casting the rim 12 separately from the lower portion of the bowl 16. The two pieces are then joined together after manufacture by wetting the surfaces to be adhered with clay slip and pressing them into contact, thus forming joint 14. The pieces bond to form a single item, which can be dried, fired and glazed using known processes. Using prior art processes, it is complex and therefore expensive to produce box rim bowls in a single piece.

Turning now to FIG. 2, two female moulds 22, 24 comprising part of pressure casting apparatus 20 are mounted on a pressure casting machine (not shown) so that the cavities 26, 28 face each other. Preferably, the moulds 22, 24 are hung on the casting machine and are arranged to be slidable in a direction substantially perpendicular to mating faces 30, 32 (known as the machine axis). It is however envisaged that other mounting arrangements may be employed within the scope of the invention.

Male moulds 34, 36 are mounted back to back between the female moulds 22, 24. The male moulds 34, 36 are preferably hung on the casting machine via a sub frame rail 54 and are movable in a plane substantially perpendicular to the machine axis. The above described arrangement may be closed to form a half bowl void between each pair of male and female moulds 22, 34 and 24, 36.

In this embodiment, four alignment pins 38, 40, 40, 42, 44 pass from one female mould 24 through the male moulds 34, 36 and into corresponding bushes fitted to the other female mould 22. In alternative classes of embodiment other aligning means such as lips and recesses may be employed. By this means, the moulds are maintained in repeatable alignment when closed.

The female moulds 22, 24 are closed and clamped using any suitable method known in the art. Pressurised slip (not shown) is introduced, and two half-bowl pieces are cast between the male and female moulds by allowing the liquid within the slip to escape through pores provided in the moulds. Some parts of the pieces are cast between two faces of the moulds (solid cast) and other parts are cast against only one face of the moulds (hollow cast), depending on the details of the particular shape, which is to be made.

After the slip has been sufficiently de-watered and casting is complete, compressed air is introduced into the structure of the male moulds 34, 36 and the pieces (not shown) are de-moulded from the male moulds. The female moulds 22, 24 are moved along the machine axis with the female moulds 22, 24 each containing a half bowl piece (not shown). At this point, the male moulds 34, 36 are moved in a direction X along a sub frame rail 54 away from the machine axis.

It is envisaged that more than one set of pressure casting apparatus 20 may be fitted to the machine to increase its throughput, and that the male moulds 34, 36 of each apparatus should be de-moulded up to the stage indicated.

The female moulds 22, 24 are then clamped back together using suitable means such as a hydraulic ram (not shown). The alignment pins 38, 40, 42, 44 ensure that the moulds 22, 24 are brought together in substantial alignment. A light clamping force is applied to all the moulds 22, 24 causing the half bowls to adhere. The adhesion of the half bowls could be improved if necessary by coating the joint face of one or both halves with slip.

Once the male moulds 34, 36 have been withdrawn and the two female moulds 22, 24 have been clamped together, a cavity 58 is advantageously created directly beneath the bowl. A “setter” 56 made of suitable absorbent material e.g. plaster, or an absorbent hydrophilic material is preferably introduced into this cavity 58 from below in a direction indicated by arrow Y, to support the joined bowl.

It is then only necessary to introduce compressed air to each female half mould 22, 24, thus de-moulding the joined bowl and leaving it supported on the setter 56. The setter may then be withdrawn using a suitable mechanical device (not shown) to produce a finished bowl.

If necessary, manual wet finishing using a sponge may be employed to produce a completed bowl, which is ready for drying, glazing and firing, using methods known in the art.

Many types of “bowl” or other complex ceramic articles could be manufactured by vertically splitting them into two parts and joining the pieces to form a standard bowl. The above described apparatus and method causes the alignment of the “halves” to be automatic and allows the degree of compression to being applied to forge the junction between the two pieces to be accurately controlled.

One particular advantage of this method is that because the male mould is separated and withdrawn away from the machine axis, it is possible to cast a half bowl without producing a separate box rim. The direction of mould separation lends itself naturally to the formation of a closed box structure.

Some bowl designs require a more complex rear outlet which could be cast by inserting an additional piece into a cut-out provided in the female moulds, and clamping it into place.

Referring to FIG. 3, whilst the manufacture of a standard “bowl” in a single piece necessarily requires the use of at least four mould parts, an apparatus 120 and method is illustrated, in which not all of the four parts are closed by external “mechanical” clamping. The apparatus may be mounted on a conventional single axis, single overhead beam casting machine. Commonly, a plurality of such apparatus is arranged in series on such a machine, such that a number of bowls may be cast simultaneously.

Female moulds 122, 124 are mounted within respective mould casings (not shown) and are provided with cavities 171, 172, 158, 159 into which an upper male mould 160 and lower male mould 166 may fit. The casings are provided in order to impart the necessary strength to the female moulds to withstand the forces induced by the pressurised slip during the casting process. The upper and lower moulds 160, 166 are designed to form a good seal with the corresponding contact points on the side moulds and are provided to form the rim and hollow base of the bowl respectively. It should be understood that in alternative embodiments one or more similar male moulds may be provided to form hollow or re-entrant portions of other ceramic articles.

In a preferred embodiment, internal clamping means also fits within cavities 158, 159 and 171, 172 respectively and is preferably in contact with the upper face of the upper male mould 160 and lower face of lower male mould 166 respectively. Support tubes 164 and 170 preferably pass therethrough.

In its simplest form, the clamping means may comprise an O-ring (not shown) formed from rubber or similar suitable resilient material that is preferably secured to the periphery of the upper/lower face of the respective male mould 160, 166. When the male moulds are held with the female moulds 122, 124, the O-ring serves to transfer the force induced by the pressurised slip to the corresponding portion of the female moulds 122, 124 thereby containing the force within the moulds, rather than transferring the force to a supporting carriage of the casting machine.

Referring in particular to FIGS. 4 and 5, in a preferred embodiment the clamping means comprises pressure pads 162 and 168. Each pad is manufactured using a substantially identical method. Therefore, only the method of manufacturing pad 162 is described in greater detail. Pad 162 comprises a sheet-like core 202, advantageously manufactured from either rigid or flexible plastics material, preferably uPVC or polyethylene. having a relatively large central aperture 208, and a plurality of relatively smaller holes 204 provided therein.

The core 202 is placed in a pad mould (not shown). A fluid inlet connector 206 secured in the desired location on the periphery of the central aperture 208. Material is poured around the core and subsequently allowed to cure so as to form an envelope 200 that encloses the core and has resilient, high elongation properties. A material having suitable properties is rubber. The pad mould is preferably shaped to conform to the outline of the face of the male mould 160, 166 with which it will ultimately be placed into contact, and has provision for a central aperture 210 to accommodate the supporting tubes 164, 170 that connect with the corresponding male mould.

Once cured, the materials of the envelope 200 and core 202 do not mutually adhere and the inlet connector 206 is arranged so as to be located at the interface of the core 202 and envelope 200. Therefore, once fluid is introduced into the pad under pressure via the inlet connector 206, the fluid separates the envelope from the core, causing the pad to expand in one axis. Excessive movement while handling is prevented by virtue of the rubber material that fills the smaller holes 204, thereby connecting the two faces of the envelope 200 at a predetermined spacing.

By using clamping means that can expand to “actively” exert a clamping force that counteracts the pressure of the clay slip, tolerances in the finished bowl can be more exactly controlled. Furthermore, the demoulding can be achieved more easily, because the pressure pads 162, 168 may be depressurised prior to the separation of the female moulds. This reduces the frictional resistance of the female moulds during separation that would otherwise be induced by the clamping force of the pressure pads.

By adjusting the hardness of the resilient material and/or the spacing of the holes 204, it is possible to vary the expansion, and therefore in a confined space, the force applied locally by the pressure pads 162 and 168. In alternative embodiments, each pad is divided into two or more independently pressurisable chambers,

In an alternative embodiment (not shown), the pressure pad may be manufactured by coiling a length of extensible resilient tubing that is closed at one end to form a substantially planar coil. The coil is then preferably placed in a mould corresponding to the final desired shape of the pad. A material such as rubber having suitable elongation properties, is then poured around the coil. Once the material has cured, a fluid may be introduced into the coiled tubing under pressure, causing the pad to expand in substantially one axis. As in the previous embodiment, an aperture is advantageously provided in the pad to permit the passage of a support tube 164, 170 therethrough. In a variant of this embodiment, a resilient bag (not shown) may replace the coiled tubing.

It is envisaged that in other classes of embodiment, other internal clamping means may be employed. For example, hydraulic “pancake” type coils, piezoelectric devices or other known devices that can exert a large force in one axis over a relatively large area.

Referring back to FIG. 3, the female moulds 122, 124 are closed, for example under the influence of a hydraulic ram mounted on the tailstock of a conventional single axis casting machine (not shown) with male moulds 160 and 166 therebetween. The compression of the female moulds is preferably controlled by shims, screw jacks or other means (not shown) that enables the spacing between the contact faces to be varied.

Once clamping is achieved in this first axis, the upper and lower pads are pressurised using a fluid medium (either liquid or gas). In a preferred embodiment, a pressurised liquid such as water, water glycol, hydraulic oil or any suitable substance that is not damaging to the pad materials is used. In the confined space between the female moulds and the corresponding wall mould this provides the force to achieve clamping in the second axis (i.e. substantially perpendicular to the machine direction). As discussed above, it is preferable to actively apply a force to the upper and lower mould so as to counteract the pressurisation of the clay slip within the mould cavity.

Support tubes 164, 170 advantageously also act as conduits to allow the fluid to enter the pads 162, 168 and to carry tubes to the upper and lower moulds to carry away water that has passed through the moulds during the moulding process and introduce compressed air for demoulding as described below.

The internal clamping arrangement ensures that all of the clamping forces are contained within the mould casings, rather than being transferred to the carriage upon which the apparatus is mounted. This in turn means that the carriage need not be of such heavy duty construction as for prior art devices.

In a particularly preferred embodiments a control system (not shown) is employed that varies the clamping force applied by the pressure pads 162, 168 in response to variations in the slip pressure within the mould cavity throughout the casting process. This reduces the stresses on the moulds and improves dimensional control in relation to the finished article.

Once clamping in both axes has been achieved, the mould cavities which remain are then filled with slip and cast. After draining and consolidating, the upper and lower pads 162 and 168 are depressurised and one of the female moulds 122 is de-moulded by injecting compressed air into its cavities. The remaining female mould 124 is then de-moulded using the same method.

The finished bowl (not shown) is then suspended between the upper and lower male moulds 160 and 166.

In a preferred embodiment, a setter (not shown) is moved into position using a hand or robotically operated external de-moulding arm so as to grip the cast bowl. The upper mould 160 may then be released from the bowl by injecting compressed air or another suitable fluid as outlined above and may then be withdrawn from within the article. The cast piece is then advantageously lifted using the setter and is preferably simultaneously de-moulded from the lower mould 166.

In a preferred embodiment, the upper and lower moulds are held on a substantially C-shaped frame that is arranged to allow one portion thereof to pivot relative to another permit demoulding to take place.

The bowl may then be removed from the casting apparatus 120 for finishing, firing and glazing operations.

The upper and lower moulds 160, 166 are moved back into their deployed positions and the side moulds 122, 124 are closed to return the apparatus 120 to its starting position, and the moulding cycle can then be repeated.

If box-rim bowls are required as illustrated in FIG. 1, the bowl 10 may be manufactured in two parts. The lower portion of the bowl 16 may be manufactured using the apparatus and method described above, and the rim portion 12 using a known process. The two portions may then be “glued” together using liquid slip along line 14.

Some types of bowl have a rear waste outlet requiring a further clamping axis in their manufacture. The above described apparatus may be adapted to include on the C-shaped frame a further male mould preferably provided with a further associated pressure pad for forming the waste outlet in this third axis. The male mould is disposed in use between two supplementary female moulds again to contain the forces induced by the clay slip within the mould cases.

It is possible to operate several sets of casting apparatus on the same machines to commence a new moulding cycle, arranged such that multiple bowls ma be cast simultaneously, and de-moulded sequentially or simultaneously.

It should be understood that the terms “upper” and “lower” have been used for case of reference only, and that the relative orientation of the male moulds and the clamping means may be altered as necessary. Furthermore, in some embodiments, clamping need not occur within the mould cavity itself, but by using other suitable means to that would enable forces to be contained within the mould casing.

1. Apparatus for manufacturing ceramic articles comprising two outer female moulds located within respective mould cases and having co-operating mating faces and a male mould arranged, in use, to be disposed in a mould cavity formed by the female moulds characterised in that the female moulds being arranged to be relatively movable in a first axis substantially perpendicular to the plane of the mating faces such that the female moulds may be brought into contact, the article being cast between the female moulds and the male mould and wherein the forces induced by the pressurised slip during the manufacturing process are thereby contained within the mould cases.

2. Apparatus according to claim 1 wherein the male mould is associated with clamping means.

3. Apparatus according to claim 2 wherein the clamping means is disposed, in use, within the mould cavity.

4. Apparatus according to claim 3 wherein the internal clamping means is so constructed and arranged as to exert a clamping force in a second axis.

5. Apparatus according to any of claims 2 to 4 wherein the clamping means is located between a face of the male mould and an inner face of at least one of the female moulds.

6. Apparatus according to claim 4 or claim 5 wherein fluid is introduced into the clamping means to provide the clamping force.

7. Apparatus according to claim 6 wherein the clamping means comprises a pressure pad.

8. Apparatus according to claim 7 wherein the pressure pad comprises a chamber enveloped by resilient material.

9. Apparatus according to claim 8 wherein the fluid is introduced under pressure into the chamber causing a clamping force to be exerted in substantially a single axis.

10. A pressure pad according to claim 9 wherein the chamber comprises a coil of resilient tubing.

11. A pressure pad according to claim 9 wherein the chamber comprises a resilient bag.

12. A pressure pad according to any one of claims 8 to 11 wherein the resilient material comprises rubber.

13. A pressure pad according to any one of claims 7 to 12 wherein an aperture is provided therein for the passage of a support tube upon which an associated mould is mounted.

14. Apparatus according to any of claims 1 to 13 wherein the article is cast in a single piece.

15. Apparatus according to any of claims 1 to 14 wherein two male moulds are provided.

16. Apparatus according to claim 15 wherein the two male moulds are arranged in back to back relationship.

17. Apparatus according to claim 16 wherein the male moulds are mounted on a track so as to permit the male moulds to be moved out of the axis of the female moulds.

18. Apparatus according to claim 17 wherein the moulds are arranged to be withdrawn in substantially opposite directions.

19. Apparatus according to claim 17 or claim 18 wherein a third male mould is provided in a third-axis.

20. Apparatus according to claim 19 wherein the ceramic article is a toilet bowl and the third male mould is arranged so as to form a waste outlet portion thereof.

21. A single axis casting machine comprising a plurality of apparatus according to any one of claims 1 to 20 suspended from an overhead beam.

22. A method of making ceramic articles comprising the steps of:
i) introducing a male mould into an envelope formed by two female moulds located within respective mould cases;
ii) clamping the male mould so as to resist the pressurisation of clay slip, once introduced in such a way as to contain the forces exerted by the slip within the mould cases;
iii) introducing pressurised clay slip so as to cast the article;
iv) de-moulding the moulds.

23. A method according to claim 22 wherein the male mould is clamped using clamping means.

24. A method according to claim 23 wherein the clamping means is a pressure pad.

25. A method according to any one of claims 22 to 24 wherein two male moulds are provided.

26. A method according to claim 25 wherein the male moulds are de-moulded in substantially opposite directions.
